(19) United States
(12) Patent Application Publication
(10) Pub. No.: US 2010/0109220 A1
(43) Pub. Date: May 6, 2010

(54) Substrate Holding Mechanism and Substrate Assembly Apparatus Including the Same

(75) Inventors: Kazuhiro Musha, Kanagawa (JP); Hirofumi Minami, Kanagawa (JP); Takafumi Kawaguchi, Kanagawa (JP)

Correspondence Address: HARNESS, DICKEY & PIERCE, P.L.C., P.O. BOX 828, BLOOMFIELD HILLS, MI, 48303, US

(73) Assignee: ULVAC, INC., Kanagawa (JP)

(21) Appl. No.: 12/596,455

(22) PCT Filed: Apr. 15, 2008
(86) PCT No.: PCT/JP2008/057367

§ 371 Date: Jan. 11, 2010

(30) Foreign Application Priority Data
Apr. 19, 2007 (JP) 2007-110372

(51) Int. Cl. B25B 1/00

(52) U.S. Cl. 269/7

(57) ABSTRACT

Object To provide a substrate assembly apparatus capable of simplifying a structure of the apparatus and performing appropriate detachment of a substrate constantly.

Solving Means A substrate assembly apparatus according to the present invention includes a support base and a holding mechanism. The support base is for supporting a lower substrate. The holding mechanism includes a holding surface and a functional element. The holding surface is for holding an upper surface of an upper substrate. The functional element is provided on the holding surface and has a holding force variable in accordance with a magnitude of a voltage. The holding mechanism causes a lower surface of the upper substrate to face an upper surface of the lower substrate supported by the support base. With this structure, it becomes possible to electrically control the holding force with respect to the substrate and simplify the structure of the holding mechanism. Further, since the holding force of the substrate can be changed smoothly, appropriate detachment is constantly allowed even with respect to a thin substrate.

### FIELD

The present invention relates to a substrate holding mechanism used in, for example, an assembly process of a liquid crystal display panel, and a substrate assembly apparatus including the substrate holding mechanism.

### BACKGROUND

A liquid crystal cell of a liquid crystal display apparatus is structured by sealing a liquid crystal layer between two transparent substrates having surfaces on which transparent electrodes, orientation films, thin film transistor (TFT) arrays, color filters, and the like are formed. As methods of producing the liquid crystal cell, two methods are conventionally known. One of them is a method of producing a liquid crystal cell by, after a substrate whose bonding surface is applied with an adhesive is bonded to the other substrate, injecting a liquid crystal layer between the two substrates. The other method is a method of producing a liquid crystal cell by bonding a substrate whose bonding surface is applied with an adhesive and a liquid crystal material to the other substrate. In any of the methods, the bonding of substrates is performed under a reduced-pressure atmosphere in view of preventing air from remaining (bubbles from being generated) in the liquid crystal cell.

As a method of bonding substrates, there is a general method of opposing two substrates in a vertical direction, aligning them, and thereafter bonding them. At this time, a mechanism for holding a substrate positioned on the upper side is necessary. As typical substrate holding mechanisms, there are known a mechanical clamp mechanism, a vacuum adsorption mechanism, an electrostatic adsorption mechanism, and the like.

However, there is a fear that the mechanical clamp mechanism causes generation of dust due to a mechanical contact with the substrate or complication of the mechanism. The vacuum adsorption mechanism is unsuitable for use in vacuum, though a structure thereof can be simplified. Further, the electrostatic adsorption mechanism can be used not only in air but also in vacuum, but has a problem that an adsorption force cannot be released rapidly because static elimination of the substrate requires long time.

On the other hand, as a substrate holding mechanism other than those described above, there is known a method of using an adhesive means (see, for example, Patent Documents 1 and 2). FIG. 9 shows a schematic structure of a substrate assembly apparatus described in Patent Document 1.

A substrate assembly apparatus 1 shown in the figure is constituted of a lower chamber unit 4 including a support base 3 that supports a lower substrate 2, and an upper chamber unit 7 including an adhesive tape 6 that holds an upper substrate 5. The lower chamber unit 4 is movable with respect to the upper chamber unit 7 within an X-Y plane, and the support base 3 is structured so as to be rotatable about a Z axis (θ direction) within the lower chamber unit 4. On the other hand, the upper chamber unit 7 is structured so as to be movable in the Z-axis direction with respect to the lower chamber unit 4. Accordingly, the lower substrate 4 is aligned with the upper substrate 5 within the upper chamber unit 7.

In the upper chamber unit 7, a roll-out unit 8 and a roll-up unit 9 of the adhesive tape 6 are installed. The adhesive tape 6 has an adhesive surface on a lower side in the figure, to which an upper surface of the upper substrate 5 is bonded and held. On an upper side of the adhesive tape 6, a pressure plate 10 is installed. The pressure plate 10 is for pressurizing the upper substrate 5 toward the lower substrate 2 and is structured so as to be capable of ascend/descend with respect to the upper chamber unit 7.

At a time of bonding the substrates, the upper substrate 5 and the lower substrate 2 are aligned with each other and thereafter the upper chamber unit 7 and the lower chamber unit 4 are coupled to each other via a seal ring 11. Subsequently, a pressure inside the chamber is reduced via an exhaust port 12. An adhesive is applied in advance to a bonding surface of the lower substrate 2 or the upper substrate 5. Then, the upper substrate 5 is bonded to the lower substrate 2 by a drive of the pressure plate 10 and the two substrates 2 and 5 are bonded to each other. After the pressure plate 10 is retracted to a position shown in the figure, the roll-up unit 9 is moved in a direction of an arrow A of the figure along the upper surface of the upper substrate 5. Accordingly, the adhesive tape 6 is detached from the upper substrate 2. After the inside of the chamber is opened to air, the chamber units 4 and 7 are separated and thus a bonded body of the lower substrate 2 and the upper substrate 5 is taken out.

Moreover, Patent Document 2 discloses a structure in which in the substrate assembly apparatus described above, the upper substrate attached to the adhesive tape is detached by a stick for pushing a substrate being inserted into a through-hole formed in the pressure plate and moved forward and backward in a vertical direction.

Patent Document 1: Japanese Patent Application Laid-open No. 2001-133745

Patent Document 2: Japanese Patent No. 3819797

### SUMMARY

### Problem to be Solved by the Invention

However, in the substrate holding mechanism using the conventional adhesive tape described above, there is a problem that a mechanism for detaching the adhesive tape from the upper substrate after the substrates are bonded is complicated. Further, there is also a fear that in a case where a thickness of the substrate is small, deformation or damage of the substrate is caused by a stress generated at a time of detaching the adhesive tape and appropriate detachment of the substrate may not be constantly performed.

The present invention has been made in view of the problems described above and it is an object of the present invention to provide a substrate holding mechanism that is capable of simplifying a structure of an apparatus and constantly performing appropriate detachment of a substrate, and a substrate assembly apparatus including the substrate holding mechanism.

### Means for solving the Problems

According to an embodiment of the present invention, there is provided a substrate holding mechanism including a holding body and a functional element.

The holding body includes a holding surface that holds a substrate.

The functional element is provided on the holding surface and has a holding force variable in accordance with a magnitude of a voltage.

According to another embodiment of the present invention, there is provided a substrate assembly apparatus including a support base and a holding mechanism.

The support base is for supporting a lower substrate.

The holding mechanism includes a holding surface and a functional element. The holding surface is for holding an upper surface of an upper substrate. The functional element is provided on the holding surface and has a holding force variable in accordance with a magnitude of a voltage. The holding mechanism causes a lower surface of the upper substrate to face an upper surface of the lower substrate supported by the support base.

### BEST MODES FOR CARRYING OUT THE INVENTION

According to an embodiment of the present invention, there is provided a substrate holding mechanism including a holding body and a functional element.

The holding body includes a holding surface that holds a substrate.

The functional element is provided on the holding surface and has a holding force variable in accordance with a magnitude of a voltage.

According to the substrate holding mechanism, it becomes possible to electrically control the holding force with respect to the substrate by the functional element provided on the holding surface. Accordingly, the structure of the holding mechanism can be simplified. Further, since the holding force of the substrate can be changed smoothly, appropriate detachment is constantly allowed even with respect to a thin substrate.

The functional element may be a functional adhesive element that has an adhesive force variable in accordance with the magnitude of a voltage.

Accordingly, it becomes possible to electrically control the holding force with respect to the substrate.

The functional adhesive element may include an adhesive medium of electrically insulating properties, electrorheological particles that are dispersed in the adhesive medium, and an electrode pair that applies a voltage to the adhesive medium.

The functional adhesive element is an adhesive element that utilizes an electrorheological effect. That is, the element disperses the electrorheological particles in a gel-like electrically insulating medium and controls aggregability of the particles on a surface of the medium in accordance with the magnitude of a voltage. Accordingly, if the gel-like medium is constituted of a material having adhesion, the adhesion of the surface of the medium becomes variable in accordance with the magnitude of a voltage.

The adhesive medium may include a first surface that is an electrode arrangement surface on which the electrode pair is arranged and a second surface that is an adhesive force control surface whose adhesive force is controlled in accordance with the magnitude of a voltage to the electrode pair.

According to the adhesive medium, a dispersion density of the electrorheological particles can be controlled by high following characteristics with respect to a change in an external voltage. Accordingly, the adhesive force of the adhesive force control surface can be changed with high responsiveness.

According to another embodiment of the present invention, there is provided a substrate assembly apparatus including a support base and a holding mechanism.

The support base is for supporting a lower substrate.

The holding mechanism includes a holding surface and a functional element. The holding surface is for holding an upper surface of an upper substrate. The functional element is provided on the holding surface and has a holding force variable in accordance with a magnitude of a voltage. The holding mechanism causes a lower surface of the upper substrate to face an upper surface of the lower substrate supported by the support base.

According to the substrate assembly apparatus, it becomes possible to electrically control the holding force with respect to the substrate by the functional element provided on the holding surface. Accordingly, the structure of the holding mechanism can be simplified. Further, since the holding force of the substrate can be changed smoothly, appropriate detachment is constantly allowed even with respect to a thin substrate.

The functional element may be a functional adhesive element that has an adhesive force variable in accordance with the magnitude of a voltage.

Accordingly, it becomes possible to electrically control the holding force with respect to the substrate.

The functional adhesive element may include an adhesive medium of electrically insulating properties, electrorheological particles that are dispersed in the adhesive medium, and an electrode pair that applies a voltage to the adhesive medium.

The functional adhesive element is an adhesive element that utilizes an electrorheological effect. That is, the element disperses the electrorheological particles in a gel-like electrically insulating medium and controls aggregability of the particles on a surface of the medium in accordance with the magnitude of a voltage. Accordingly, if the gel-like medium is constituted of a material having adhesion, the adhesion of the surface of the medium becomes variable in accordance with the magnitude of a voltage.

The adhesive medium may include a first surface that is an electrode arrangement surface on which the electrode pair is arranged and a second surface that is an adhesive force control surface whose adhesive force is controlled in accordance with the magnitude of a voltage to the electrode pair.

According to the adhesive medium, a dispersion density of the electrorheological particles can be controlled by high following characteristics with respect to a change in an external voltage. Accordingly, the adhesive force of the adhesive force control surface can be changed with high responsiveness.

The substrate assembly apparatus may further include a reversal mechanism that reverses the upper substrate upside down.

Accordingly, it becomes possible to reverse the upper substrate upside down and facilitate an opposite arrangement of the upper substrate with respect to the lower substrate.

The substrate assembly apparatus may further include a pressurization mechanism that pressurizes the upper substrate toward the lower substrate.

Accordingly, it becomes possible to pressurize the upper substrate to the lower substrate and facilitate bonding of the upper substrate and the lower substrate.

Here, the functional adhesive element is provided on the substrate holding surface of the holding mechanism. In this case, the entire holding surface may be constituted of a single functional adhesive element or the functional adhesive element may be arranged at a plurality of positions of the holding surface.

On the other hand, the functional element is not limited to the structure in which the holding force of the substrate is expressed by the adhesive force of the functional element. For example, a vacuum adsorption mechanism or an electrostatic chuck mechanism may be added to the holding mechanism and those adsorption mechanisms may be used as a holding force generation source of the substrate. In this case, the functional element can be caused to function as a detachment mechanism that is driven when the substrate is detached from the holding surface after a substrate holding action by the adsorption source is released.

That is, in a case where a functional element that utilizes an electrorheological effect is used as the functional element described above, a thickness of the functional element is changed at the same time when particle distances of the electrorheological particles are changed in accordance with a magnitude of a voltage. Accordingly, by adjusting a voltage such that the element thickness becomes larger when the substrate is detached, it is possible to separate the substrate from the holding surface by the functional element. It should be noted that in this case, the electrically insulating medium that bears the electrorheological particles is constituted of a non-adhesive material.

In particular, in a case where a vacuum adsorption mechanism or an electrostatic chuck mechanism is used as an adsorption source, there may occur a case where the substrate cannot be easily detached (separated) from the holding surface due to a coherent action between the holding surface and the substrate even after the adsorption force is released. In such a case, it is possible to adjust the holding force between the substrate and the holding surface by an extension action of the functional element, and thus facilitate detachment (dechuck) of the substrate from the holding surface and enhance the dechuck performance.

Based on such a viewpoint, the functional element used mainly in the detachment mechanism of the substrate is not limited to the functional element that utilizes an electrorheological effect, and a functional element in which a volume or a shape is changed due to a voltage change or a heat change utilizing that, such as a piezoelectric element, a pyroelectric element, a shape-memory element, and a bimetallic element, is widely applicable.

### DRAWING DESCRIPTION

FIG. 1 are side views for describing a schematic structure and an operation of a substrate assembly apparatus according to an embodiment of the present invention;

FIG. 2 is a schematic perspective view of a main portion showing a structure of a holding body for an upper substrate in the substrate assembly apparatus of FIG. 1;

FIG. 3 are cross-sectional side views for describing a schematic structure and an operation of a functional adhesive element that is provided to the holding body shown in FIG. 2;

FIG. 4 are views showing a structural example of an electrode pair for the functional adhesive element shown in FIG. 3;

FIG. 5 are cross-sectional side views for describing a schematic structure and an operation of a substrate holding apparatus described in another embodiment of the present invention;

FIG. 6 are views showing a modification example of the structure of FIG. 5;

FIG. 7 are views showing another modification example of the structure of FIG. 5;

FIG. 8 are cross-sectional side views for describing a schematic structure and an operation of a substrate holding apparatus described in still another embodiment of the present invention; and

FIG. 9 is a schematic structural view of a conventional substrate assembly apparatus.

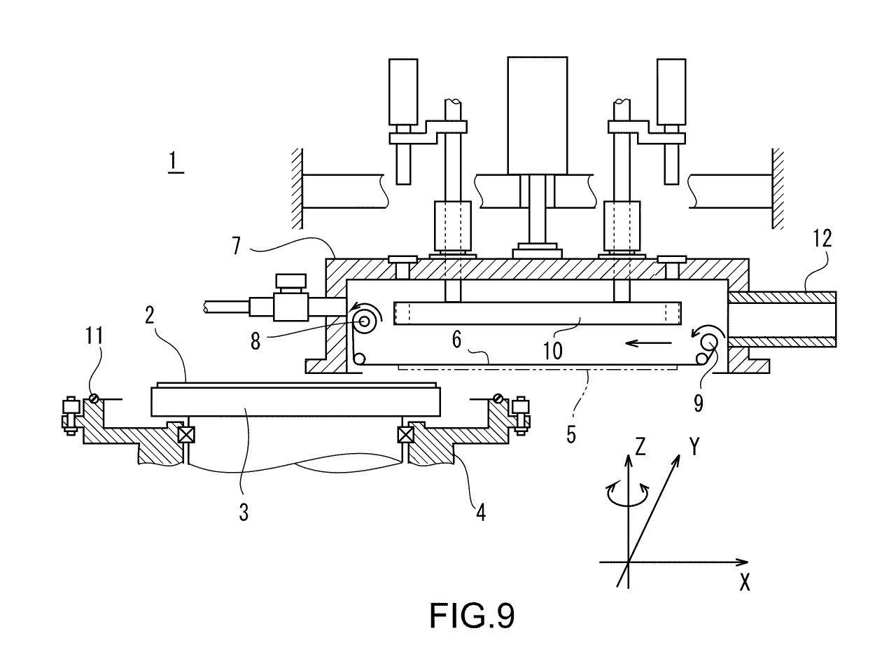

### DETAILED DESCRIPTION

Hereinafter, embodiments of the present invention will be described with reference to the drawings.

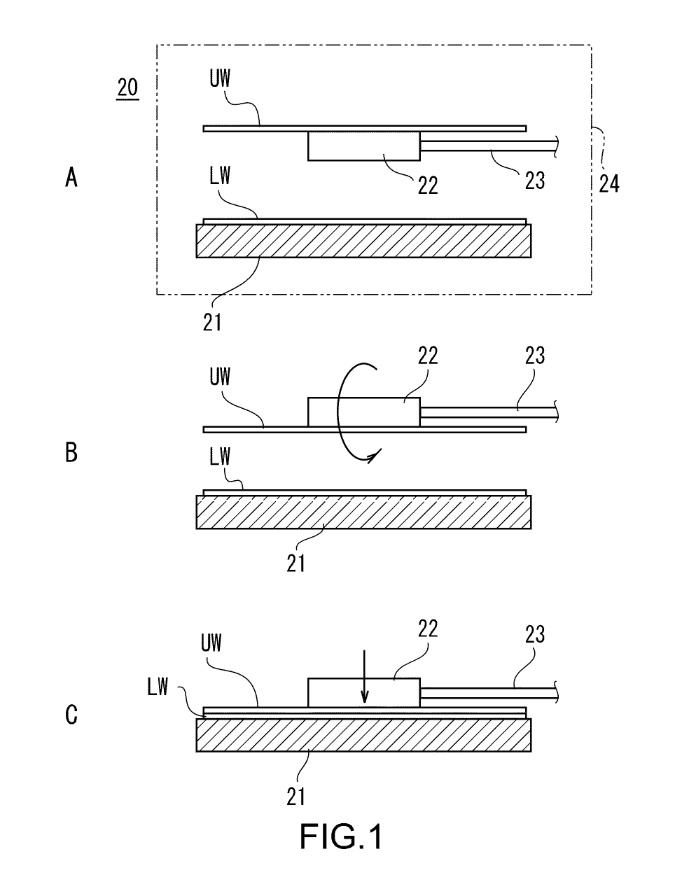

FIG. 1 are schematic structural views for describing a substrate assembly apparatus and an operation thereof according to an embodiment of the present invention. A substrate assembly apparatus 20 of this embodiment is structured as a substrate bonding apparatus for bonding a lower substrate LW and an upper substrate UW to each other.

The substrate assembly apparatus 20 includes a support base 21 that supports the lower substrate LW and a holding body 22 that holds the upper substrate UW. The holding body 22 includes a reversal mechanism portion (not shown) that reverses the upper substrate UW upside down while holding a non-bonding surface side of the upper substrate UW so that a state shown in FIG. 1A in which a bonding surface faces upwardly becomes a state shown in FIG. 1B in which the bonding surface faces downwardly. Further, the holding body 22 includes a pressurization mechanism portion (not shown) that brings the upper substrate UW close to the lower substrate LW that is supported by the support base 21 and thereafter pressurizes the upper substrate UW toward the lower substrate LW as shown in FIG. 1C.

The reversal mechanism portion and the pressurization mechanism portion can be constituted of, for example, drive sources such as a motor and a cylinder apparatus provided on a proximal end side of a drive shaft 23 that supports the holding body 22. It should be noted that the holding body 22, the drive shaft 23, the reversal mechanism portion, and the pressurization mechanism portion constitute a “holding mechanism” according to the present invention. Further, the reversal mechanism portion is not limited to the example in which the substrate is reversed by the holding body 22 being rotated about a shaft core of the drive shaft 23, and may reverse the substrate upside down by a gyration motion with the drive shaft 23 as a radius of rotation.

Each of the lower substrate LW and the upper substrate UW is constituted of a glass substrate, a silicon substrate, or the like. In this case, the substrate assembly apparatus 20 is used for, for example, producing a liquid crystal cell (liquid crystal display panel) and an SOI (Silicon On Insulator) substrate.

In this embodiment, the substrate assembly apparatus 20 is used in a production process of a liquid crystal cell. Specifically, for example, an adhesive (sealing agent) for bonding and a spacer for forming a gap are applied to or spread on a bonding surface of the lower substrate LW in advance. After that, a liquid crystal material is injected between the bonded substrates and thus a liquid crystal cell is completed. Alternatively, there is employed a method in which a liquid crystal material is applied in advance to the bonding surface of the lower substrate LW and the liquid crystal material is filled between the substrates simultaneously with the bonding of the upper substrate UW.

The bonding of the substrates can be performed in air. However, in the case where the substrate assembly apparatus 20 is used in the production process of a liquid crystal cell as described above, the support base 21 and the holding body 22 are installed in a vacuum chamber 24 (FIG. 1A) for the purpose of preventing air from remaining (bubbles from being generated) between the substrates and thus the substrates are bonded under a reduced-pressure atmosphere.

The lower substrate LW is supported by the support base 21 with the bonding surface facing upwardly. The support base 21 is provided with a positioning mechanism for the lower substrate LW as appropriate. A form of supporting the lower substrate LW by the support base 21 is not particularly limited, and in addition to a placement of the lower substrate LW by a self-weight, an electrostatic adsorption mechanism, an adhesion mechanism, a mechanical clamp mechanism, and the like can be employed. It should be noted that the support base 21 can be moved and rotated within a horizontal plane and is structured so that the lower substrate LW can be aligned with the upper substrate UW that is held by the holding body 22.

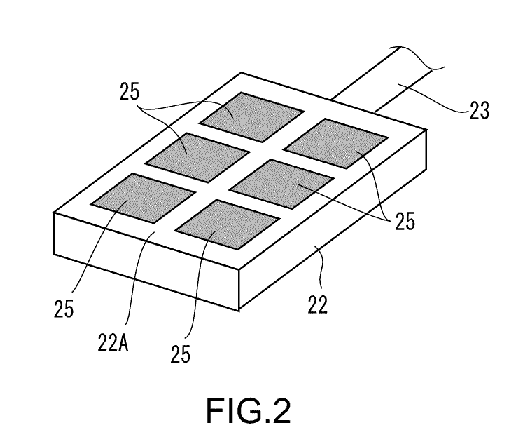

Meanwhile, a structure of the holding body 22 that holds the upper substrate UW will be described. FIG. 2 is a schematic perspective view showing a structure of a holding surface 22A of the holding body 22. The holding surface 22A is provided with functional adhesive elements 25 for holding the upper substrate UW. The functional adhesive element 25 is a specific example of a “functional element” according to the present invention, in which a holding force is variable in accordance with a magnitude of a voltage.

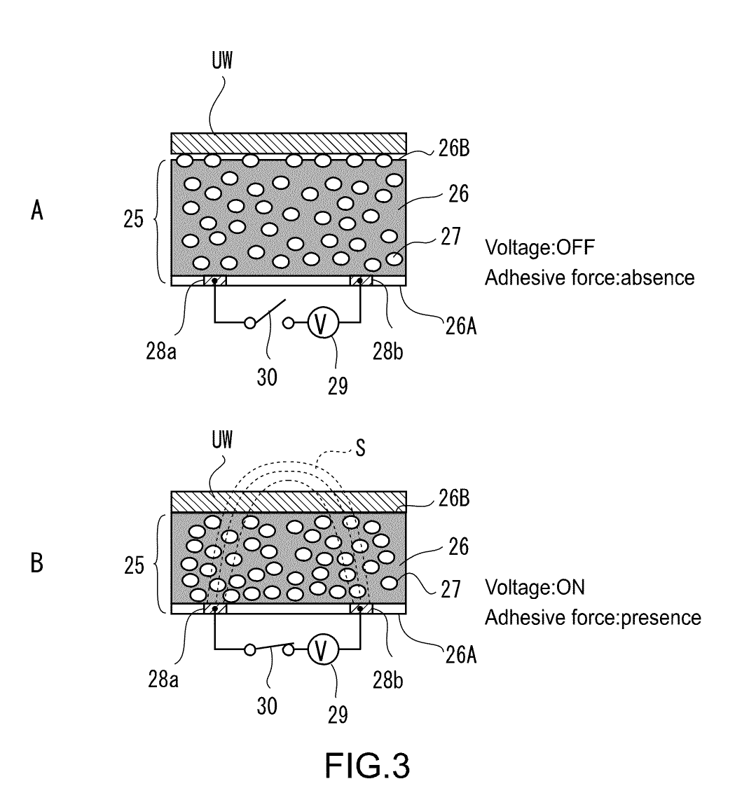

FIGS. 3A and 3B are cross-sectional views schematically showing a structure of the functional adhesive element 25. The functional adhesive element 25 is an element that utilizes an electrorheological effect (ER effect) and includes a medium 26 made of a gel-like electrically insulating material, electrorheological particles 27 that are dispersed in the medium 26, and a pair of electrodes 28a, 28b that applies a voltage to the particles 27. The particles 27 are not particularly limited as long as they show an electrorheological effect while dispersing in the medium 26, and solid particles such as silica gel, carbon particles, composite particles constituted of a core material of an organic polymer compound and a surface layer of electro-semiconductive inorganic particles, and the like can be used (see Japanese Patent Application Laid-open No. 2005-255701).

In particular, in the functional adhesive element 25 in this embodiment, the medium 26 is constituted of an adhesive material. Examples of such an adhesive material include a fluorine-based resin and a silicone resin. Moreover, one surface 26A of the medium 26 is set as an electrode formation surface on which the electrode pair 28a, 28b is arranged and the other surface 26B is set as an adhesive force control surface whose adhesive force is controlled in accordance with a magnitude of a voltage between the electrode pair 28a, 28b.

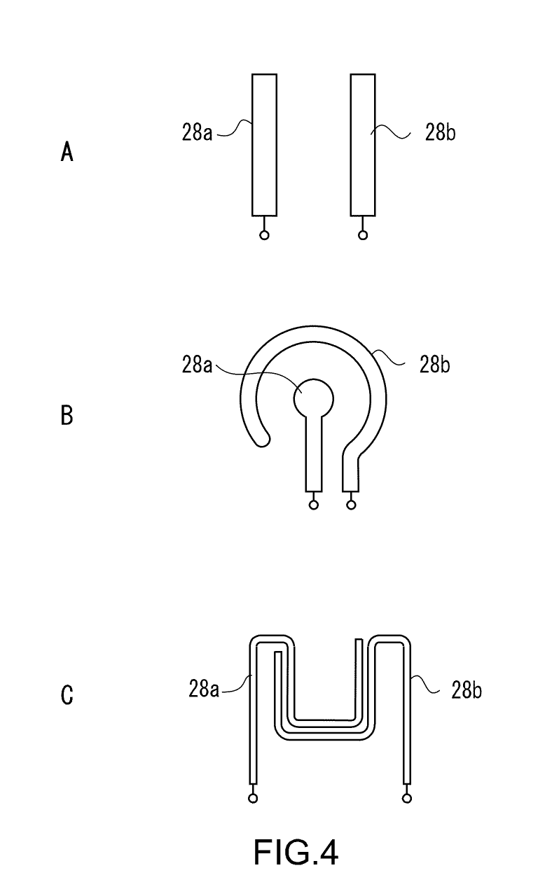

A predetermined voltage supply 29 is connected between the electrode 28a and the electrode 28b and a voltage-off state shown in FIG. 3A and a voltage-on state shown in FIG. 3B are obtained by flipping a switch 30. The voltage supply 29 may be a DC power supply or an AC power supply. The arrangement example of the electrodes 28a, 28b is not particularly limited. For example, in addition to a structure in which the two electrodes 28a, 28b are arranged in parallel to each other as shown in FIG. 4A, a structural example in which one electrode 28a is arranged so as to be surrounded by the other electrode 28b as shown in FIG. 4B, a structural example in which the electrodes 28a, 28b are formed to be curved within the electrode formation surface 26A as shown in FIG. 4C, and the like can be employed. An on/off operation of the voltage with respect to the electrodes 28a, 28b is performed in, for example, a main control portion of the substrate assembly apparatus 20.

In the voltage-off state shown in FIG. 3A, the functional adhesive element 25 is in a stable state in which the particles 27 are dispersed at certain particle distances or more due to viscoelasticity of the medium 26 and project on the surface of the medium 26. Accordingly, the adhesive force of the adhesive force control surface 26B disappears.

On the other hand, in the voltage-on state shown in FIG. 3B, the particles 27 cause dielectric polarization and collect toward a line of electric force S. Thus, the particles 27 distributed on the surface of the medium 26 are buried inside the medium 26 and simultaneously a thickness of the medium 26 is reduced. Accordingly, the adhesive force control surface 26B is structured on the surface of the medium 26, with the result that a certain adhesive force is expressed. The adhesive force of the medium 26 at this time is set to a magnitude at which the holding state of the upper substrate UW can be kept stable even in the state where the bonding surface of the upper substrate UW is opposed to the lower substrate LW as shown in FIG. 1B (adhesive force with which detachment is not caused due to self-weight of substrate). On the other hand, it is also possible to, by changing the magnitude of a voltage, adjust an amount of projection of the particles 27 with respect to the surface of the medium 26 and change the adhesive force of the adhesive force control surface 26B.

The functional adhesive element 25 as structured above is plurally provided on the holding surface 22A of the holding body 22. It should be noted that the entire area of the holding surface 22A may be covered with a single functional adhesive element 25. Further, the holding body 22 is not limited to the example in which the holding body 22 is structured to have a size capable of holding the center potion of the upper substrate UW, and may be structured to have a size capable of holding the entire area of the non-bonding surface of the upper substrate UW.

Next, an action of the substrate assembly apparatus 20 of this embodiment as structured above will be described.

With reference to FIG. 1A, the vacuum chamber 24 is evacuated to a predetermined reduced-pressure atmosphere and maintained. The lower substrate LW is supported on the support base 21. An adhesive (sealing agent), a spacer, a liquid crystal material, and the like are applied to or spread on a predetermined area of the upper surface (bonding surface) of the lower substrate LW in advance.

Further, the upper substrate UW is held by the holding surface of the holding body 22. At this time, the functional adhesive elements 25 provided on the holding surface 22A of the holding body 22 are brought to the voltage-on state shown in FIG. 3B and an original adhesive force of the medium 26 is expressed, with the result that the upper substrate UW is held.

Next, as shown in FIG. 1B, the holding body 22 is rotated 180 degrees about the drive shaft 23 and thus the upper substrate UW is reversed upside down. Accordingly, the upper substrate UW is opposed to the lower substrate LW in a state where the upper surface thereof is held by the holding body 22. After that, by the support base 21 being moved or rotated within the horizontal plane, alignment of the upper substrate UW and the lower substrate LW is performed. It should be noted that the alignment of the substrates may be performed by the holding body 22 side being moved.

Subsequently, after the holding body 22 is caused to descend and the upper substrate UW is brought close to the lower substrate LW, the upper substrate UW is pressurized toward the lower substrate LW as shown in FIG. 1C. Accordingly, the upper substrate UW and the lower substrate LW are bonded to each other and simultaneously a liquid crystal cell is manufactured.

After the bonding of the substrates, the functional adhesive elements 25 of the holding body 22 are switched to the voltage-off state shown in FIG. 3A. As a result, the electrorheological particles 27 project from the adhesive force control surface 26B of the medium 26, with the result that the adhesive force of the adhesive force control surface 26B is lowered and the holding force with respect to the upper substrate UW disappears. As described above, the holding body 22 is separated from the upper surface of the upper substrate UW.

As described above, according to this embodiment, since the holding body 22 having the functional adhesive elements 25 on the holding surface 22A is used as a holding mechanism that holds the upper substrate UW, the holding force with respect to the substrate UW can be electrically controlled. Accordingly, the structure of the holding mechanism can be simplified.

Moreover, since the holding force of the substrate can be changed smoothly, appropriate separation can be performed without causing warpage or deformation even with respect to a thin substrate. Further, detachment of the substrate can be realized without requiring a complicated detachment mechanism. Furthermore, there is no concern about generation of dust at the detachment of the substrate, and the holding mechanism is appropriate to be used not only in air but also in vacuum.

In addition, since the functional adhesive elements 25 described above can control a dispersion density of the electrorheological particles 27 by high following characteristics with respect to a change in an external voltage, the adhesive force of the adhesive force control surface 26B can be changed with high responsiveness. Accordingly, it becomes possible to readily separate the holding body 22 from the upper substrate UW after the bonding of the substrates is completed, with the result that productivity can be improved.

Subsequently, another embodiment of the present invention will be described. In the following embodiment, a vacuum adsorption mechanism or an electrostatic chuck mechanism is used as a generation source of a substrate holding force, and the functional element for adjusting a holding force according to the present invention is used as a detachment mechanism of a substrate.

That is, the following embodiment is a holding apparatus of an object to be processed such as a substrate, and includes an adsorption mechanism having a holding surface and a detachment mechanism for detaching or separating a substrate from the holding surface, the detachment mechanism being constituted of a functional element in which a holding force is variable in accordance with a magnitude of a voltage. The holding apparatus as structured above is not limited to the example in which it is structured as a holding mechanism of an upper substrate in a substrate assembly apparatus, and is also applicable to a supporting base that supports a lower substrate. Further, the holding apparatus is applicable not only to a substrate assembly apparatus but also to a holding mechanism for aligning and transferring a substrate in a substrate transfer robot or the like.

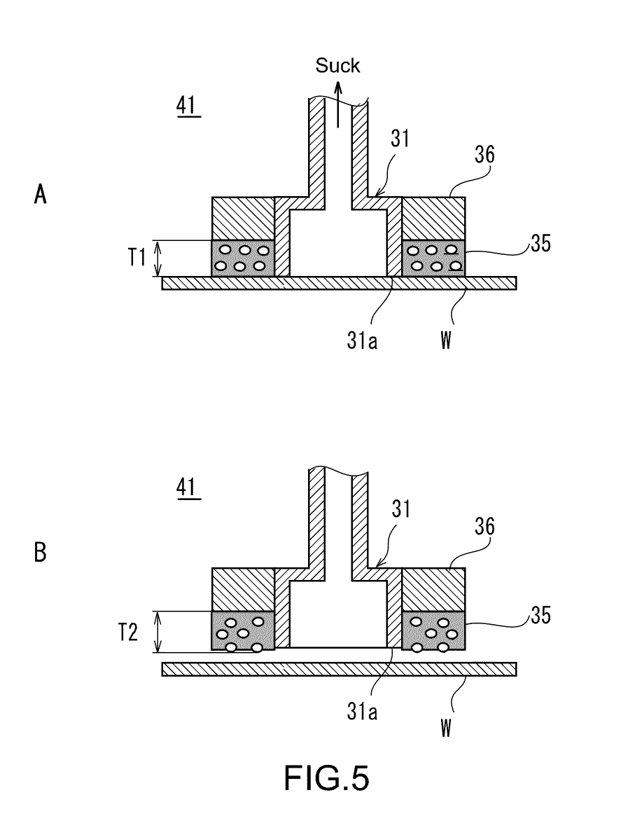

FIGS. 5A and 5B show a schematic structure of a holding mechanism 41 that includes a vacuum adsorption mechanism 31 as a holding force generation source. The vacuum adsorption mechanism 31 sucks and holds a substrate W using a pressure difference with a pressure (for example, atmospheric pressure) surrounding the substrate W. On the periphery of the vacuum adsorption mechanism 31, a functional element 35 according to the present invention and a base 36 that supports the functional element 35 are attached.

The functional element 35 is constituted of an element that utilizes an electrorheological effect and includes a medium having electrical insulation properties, electrorheological particles that are dispersed in the medium, and an electrode pair that applies a voltage to the medium. It should be noted that in this example, the medium is constituted of a non-adhesive material. Moreover, the electrode pair is not limited to the structure as being arranged adjacently to one surface side as shown in FIG. 3, and can be arranged opposed to each other so as to interpose the medium. In this case, a similar effect can be obtained with a small voltage, with the result that a drive voltage of the functional element can be reduced.

In the functional element that utilizes an electrorheological effect, a thickness of the element is changed at the same time when particle distances of the electrorheological particles are changed in accordance with a magnitude of a voltage. Accordingly, by electrically changing the element thickness of the functional element 35, it becomes possible to adjust a holding force between the substrate W and a holding surface (adsorption portion) 31a. Specifically, at a time of adsorption of the substrate W shown in FIG. 5A, the functional element 35 is applied with a voltage and an element thickness T1 is kept thin. On the other hand, at a time of releasing the holding force of the substrate W shown in FIG. 5B, the application of the voltage to the functional element 35 is released and an element thickness T2 is extended, and the substrate W is pressed in a direction separate from the holding surface 31a.

In a case of a holding mechanism including a vacuum adsorption mechanism as a holding force generation source, there may be a case where separation from a substrate is not performed easily due to an influence of a coherent force remaining between a holding surface and the substrate even after a chuck operation is released. According to this embodiment, as described above, by performing the voltage-off operation of the functional element 35 after the holding force is released, it is possible to prompt separation of the substrate W from the holding surface 31a by an extension action of the element thickness of the functional element 35 and realize a rapid dechuck operation.

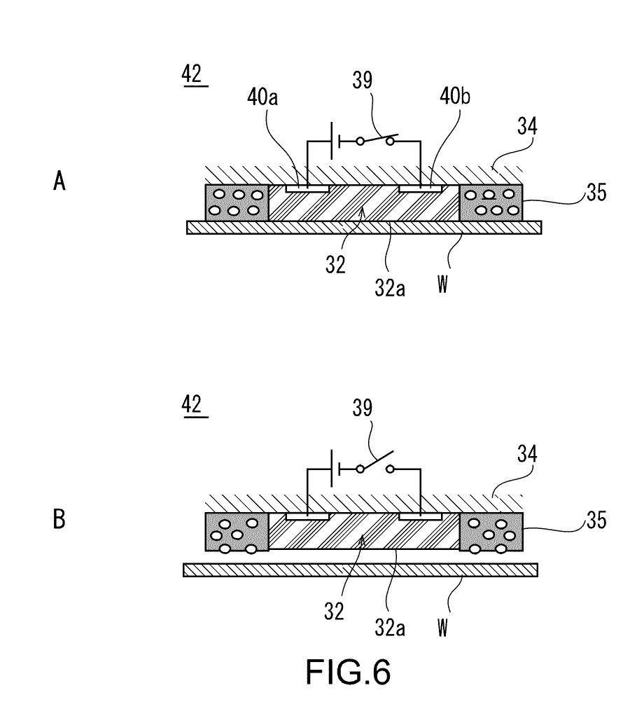

On the other hand, FIGS. 6A and 6B show a schematic structure of a holding mechanism 42 including an electrostatic chuck mechanism 32 as a holding force generation source. The electrostatic chuck mechanism 32 applies a voltage to a chuck electrode or releases the voltage by flipping a switch 39 to thereby control an adsorption operation of the substrate W on a holding surface 32a. On the periphery of the electrostatic chuck mechanism 32, the functional element 35 having the above-mentioned structure and a base 34 that supports the functional element 35 are attached.

The functional element 35 has a function of adjusting a holding force between the substrate W and the holding surface 32a by electrically changing the element thickness. Specifically, at a time of adsorption of the substrate W shown in FIG. 6A, the functional element 35 is applied with a voltage, and a substrate adsorption operation by the electrostatic chuck mechanism 32 is ensured. On the other hand, at a time of releasing the holding force of the substrate W shown in FIG. 6B, the application of the voltage to the functional element 35 is released and an element thickness is extended and the substrate W is pressed in a direction separate from the holding surface 32a.

In a case of a holding mechanism including an electrostatic chuck mechanism as a holding force generation source, there may be a case where separation from a substrate is not performed easily due to an influence of charges remaining on the substrate even after a chuck operation is released. According to this embodiment, it is possible to prompt the separation of the substrate W from the holding surface 32a by an extension action of the element thickness of the functional element 35 and realize a rapid dechuck operation.

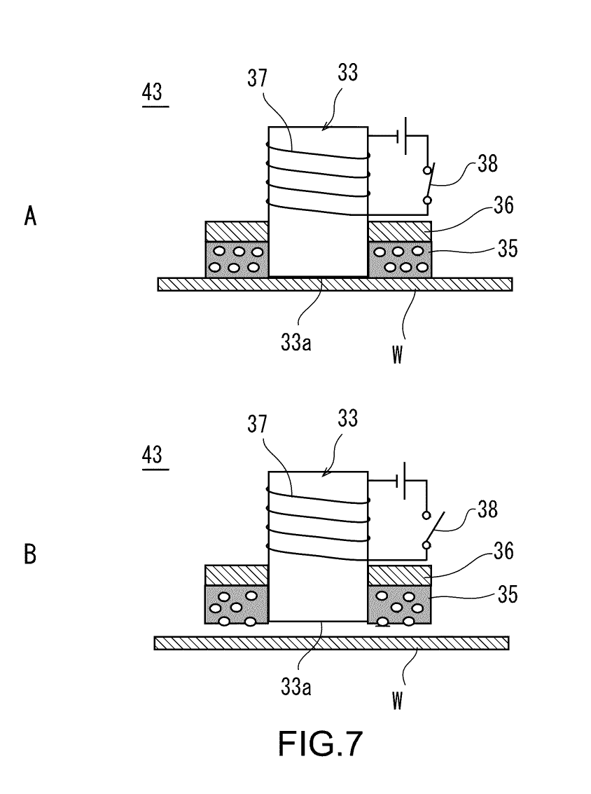

FIGS. 7A and 7B show a schematic structure of a holding mechanism 43 including an electromagnet 33 as a holding force generation source. The electromagnet 33 supplies a current to a coil 37 or releases the supply of a current by flipping a switch 38 and controls an electromagnetic adsorption operation of the substrate W on a holding surface 33a. This example is applicable to the substrate W including a ferromagnetic metal layer of iron, nickel, cobalt, or the like. On the periphery of the electromagnet 33, the functional element 35 having the above-mentioned structure and a base 36 that supports the functional element 35 are attached.

The functional element 35 has a function of adjusting a holding force between the substrate W and the holding surface 33a by electrically changing the element thickness. Specifically, at a time of adsorption of the substrate W shown in FIG. 7A, the functional element 35 is applied with a voltage, and a substrate adsorption operation by the electromagnet 33 is ensured. On the other hand, at a time of releasing the holding force of the substrate W shown in FIG. 7B, the application of the voltage to the functional element 35 is released and an element thickness is extended, and the substrate W is pressed in a direction separate from the holding surface 33a.

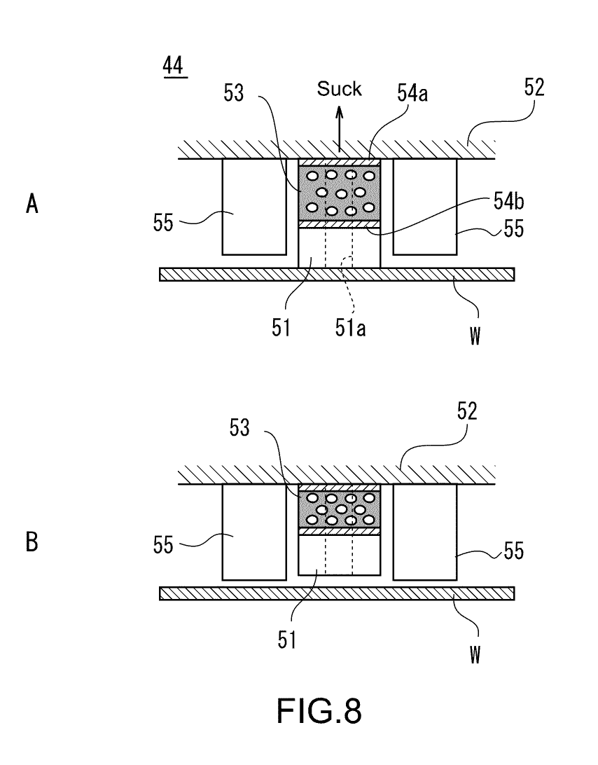

On the other hand, contrary to the examples as described above, the holding mechanism may have a structure in which the substrate is separated from the holding force generation source when the functional element is applied with voltage and the substrate is held by the holding force generation source when the voltage application to the functional element is released. FIGS. 8A and 8B show an example of the structure.

In a holding mechanism 44 shown in FIG. 8A, a holding force generation source 51 is attached to a base 52 via a functional element 53, and a stopper 55 for separating a substrate is provided on the periphery of the holding force generation source 51. A vacuum adsorption mechanism, an electrostatic chuck mechanism, and the like are applicable to the holding force generation source 51, and in the example of the figure, the holding force generation source 51 is structured with the vacuum adsorption mechanism. It should be noted that 51a is a suction hole, which is formed by, for example, passing through the functional element 53 or detouring the functional element 53.

The functional element 53 is constituted of an element that utilizes an electrorheological effect and includes a medium having electrical insulation properties, electrorheological particles that are dispersed in the medium, and an electrode pair 54a, 54b that applies a voltage to the medium. The electrode pair 54a, 54b is arranged opposed to each other so as to interpose the medium. The electrode 54a is fixed to the base 52 and the other electrode 54b is fixed to the holding force generation source 51.

In the holding force generation source 51, a substrate holding surface projects from a tip end of the stopper 55 as shown in FIG. 8A when a voltage is not applied to the electrodes 58a, 58b. Further, when a voltage is applied to the electrodes 58a, 58b, the substrate holding surface is drawn into the base 52 side from the tip end of the stopper 55 as shown in FIG. 8B due to the reduction of the element thickness of the functional element 53. Accordingly, in a case where the substrate W is sucked and held, the holding force generation source 51 can hold the substrate W by releasing the voltage application to the functional element 53 as shown in FIG. 8A. In a case where the holding force is released, detachment of the substrate W from the holding surface by the stopper 55 can be prompted by applying a voltage to the functional element 53 as shown in FIG. 8B.

According to this structure, since the holding operation of the substrate W can be performed in a state where the voltage application to the functional element 53 is released, it is possible to prevent the substrate from dropping when a failure occurs to the voltage application.

Hereinabove, though the embodiments of the present invention have been described, the present invention is of cause not limited thereto, and various modifications can be made based on the technical idea of the present invention.

In the embodiment above, for example, the example in which the functional adhesive element 25 is applied to the holding mechanism (holding body 22) of the upper substrate UW has been described, but without being limited thereto, the support base 21 that supports the lower substrate LW may be provided with the functional adhesive element 25. Accordingly, it becomes possible to take out the bonded substrates from the support base 21 rapidly, easily, and appropriately.

Moreover, in the embodiment above, the example in which the functional element that utilizes an electrorheological effect is used in the detachment mechanism of the substrate has been described, but without being limited thereto, for example, a functional element in which a volume or a shape is changed due to a voltage change or a heat change utilizing that, such as a piezoelectric element, a pyroelectric element, a shape-memory element, and a bimetallic element, may be used.

What is claimed is:

1. A substrate holding mechanism, comprising:
a holding body including a holding surface that holds a substrate; and
a functional element that is provided on the holding surface and has a holding force variable in accordance with a magnitude of a voltage.

2. The substrate holding mechanism according to claim 1,
wherein the functional element is a functional adhesive element that has an adhesive force variable in accordance with the magnitude of a voltage.

3. The substrate holding mechanism according to claim 2,
wherein the functional adhesive element includes
an adhesive medium of electrically insulating properties,
electrorheological particles that are dispersed in the adhesive medium, and
an electrode pair that applies a voltage to the adhesive medium.

4. The substrate holding mechanism according to claim 3,
wherein the adhesive medium includes
a first surface that is an electrode arrangement surface on which the electrode pair is arranged, and
a second surface that is an adhesive force control surface whose adhesive force is controlled in accordance with the magnitude of a voltage to the electrode pair.

5. A substrate assembly apparatus, comprising:
a support base for supporting a lower substrate; and
a holding mechanism including a holding surface for holding an upper surface of an upper substrate and a functional element that is provided on the holding surface and has a holding force variable in accordance with a magnitude of a voltage, the holding mechanism causing a lower surface of the upper substrate to face an upper surface of the lower substrate supported by the support base.

6. The substrate assembly apparatus according to claim 5,
wherein the functional element is a functional adhesive element that has an adhesive force variable in accordance with the magnitude of a voltage.

7. The substrate assembly apparatus according to claim 6,
wherein the functional adhesive element includes
an adhesive medium of electrically insulating properties,
electrorheological particles that are dispersed in the adhesive medium, and
an electrode pair that applies a voltage to the adhesive medium.

8. The substrate assembly apparatus according to claim 7,
wherein the adhesive medium includes
a first surface that is an electrode arrangement surface on which the electrode pair is arranged, and
a second surface that is an adhesive force control surface whose adhesive force is controlled in accordance with the magnitude of a voltage to the electrode pair.

9. The substrate assembly apparatus according to claim 5, further comprising
a reversal mechanism that reverses the upper substrate upside down.

10. The substrate assembly apparatus according to claim 5, further comprising
a pressurization mechanism that pressurizes the upper substrate toward the lower substrate.
